(19) United States
(12) Patent Application Publication
(10) Pub. No.: US 2026/0212060 A1
(43) Pub. Date: Jul. 23, 2026

(54) METHOD FOR DETERMINING CRITICAL LIFTING DEPTH OF BUILDING BASED ON NUMERICAL SIMULATION

(71) Applicant: Beijing Hengxiang Hongye Foundation Reinforcement Technology Co., Ltd, Beijing (CN)

(72) Inventor: Tengyue CUI, Beijing (CN)

(73) Assignee: Beijing Hengxiang Hongye Foundation Reinforcement Technology Co., Ltd, Beijing (CN)

(21) Appl. No.: 19/646,642

(22) Filed: Apr. 14, 2026

Related U.S. Application Data
(63) Continuation of application No. PCT/CN2025/070742, filed on Jan. 6, 2025.

(51) Int. Cl. G06F 30/13; G06F 111/10

(52) U.S. Cl. CPC G06F 30/13; G06F 2111/10

(57) ABSTRACT

A method for determining a critical lifting depth of a building based on numerical simulation includes: establishing an initial building model based on a Midas-gts numerical modeling system; performing simulated lifting respectively on a plurality of lifting surfaces in the initial building model; obtaining a plurality of primary simulated settlement displacements of the initial building model after simulated lifting; taking a depth of a lifting surface corresponding to a primary simulated settlement displacement having a maximum difference from an initial settlement displacement as an initial critical lifting depth; performing secondary simulated lifting on lifting surfaces at positions above and below the initial critical lifting surface; and determining whether there exists a lifting surface having a larger difference; in response to the existence, taking a corresponding depth as a critical lifting depth; in response to the non-existence, taking the initial critical lifting depth as the critical lifting depth.

### CROSS-REFERENCE TO RELATED APPLICATIONS

The application claims priority to Chinese patent application No. 2023117057097, filed on Dec. 12, 2023, the entire contents of which are incorporated herein by reference.

### TECHNICAL FIELD

The present disclosure relates to the technical field of building foundation rectification and lifting, and in particular to a method for determining a critical lifting depth of a building based on numerical simulation.

### BACKGROUND

Currently, the proliferation of high-rise buildings has resulted in more frequent occurrences of uneven settlement caused by various reasons. Grouting rectification and lifting technology has prominent advantages in terms of rectification effects, working space, and environmental factors, and compaction grouting technology can effectively cause ground lifting, and has advantages such as economy, high efficiency, and environmental protection, making it widely used in building rectification and lifting projects. However, for compaction grouting to achieve a lifting effect, selecting an appropriate grouting position is crucial, because the lifting effect does not occur at any depth. When the depth is too shallow, the overburden pressure is insufficient, the soil cannot be compacted, and grout runout is prone to occur; and when the depth is too deep, the pressure provided by a grout bulb is insufficient to lift the soil, and a fracturing effect occurs instead. Therefore, a critical lifting depth of a building should be determined, such that grouting at this depth yields the best lifting effect and is more economical. However, in conventional solutions, the critical lifting depth is usually determined based on construction experience. Consequently, the determined critical lifting depth is inaccurate, which poses significant construction risks and problems, thereby greatly compromising the lifting effect, and leading to poor lifting efficiency and effectiveness.

### SUMMARY

An objective of the present disclosure is to solve at least one technical problem in the background, and to provide a method for determining a critical lifting depth of a building based on numerical simulation.

To achieve the above objective, the present disclosure provides a method for determining a critical lifting depth of a building based on numerical simulation, including:
based on a Midas-gts numerical modeling system, establishing an initial building model representing a building undergoing settlement, and acquiring an initial settlement displacement of the building according to the initial building model;
performing a plurality of primary simulated lifting operations to varying degrees respectively on a plurality of lifting surfaces representing different stratum depths in the initial building model;
obtaining a plurality of primary simulated settlement displacements of the initial building model after simulated lifting according to primary simulated lifting results;
comparing each primary simulated settlement displacement with the initial settlement displacement, and taking a lifting surface corresponding to a primary simulated settlement displacement having a maximum difference from the initial settlement displacement as an initial critical lifting surface, and a depth corresponding thereto as an initial critical lifting depth;
performing a plurality of secondary simulated lifting operations to varying degrees on different lifting surfaces at positions above and below the initial critical lifting surface; and
determining whether there exists a lifting surface having a larger difference from the initial settlement displacement according to secondary simulated lifting results; in response to the existence of the lifting surface, taking the lifting surface having the larger difference as a critical lifting surface, and a depth corresponding thereto as a critical lifting depth; and in response to the non-existence of the lifting surface, taking the initial critical lifting surface as the critical lifting surface, and the initial critical lifting depth as the critical lifting depth.

According to an aspect of the present disclosure, the establishing an initial building model representing a building undergoing settlement includes:
based on a Midas-gts numerical modeling system, establishing a stratum geometric model and a building geometric model according to geological survey data parameters and building construction drawing data parameters;
inputting material property parameters into the stratum geometric model and the building geometric model, respectively;
meshing the stratum geometric model and the building geometric model; and
loading gravity loads and static soil boundary conditions onto the meshed stratum geometric model and building geometric model to form the initial building model; where

the material property parameters include an elastic modulus, a void ratio, a Poisson's ratio, and a unit weight.

According to an aspect of the present disclosure, the performing a plurality of primary simulated lifting operations to varying degrees respectively on a plurality of lifting surfaces representing different stratum depths in the initial building model includes:
selecting a plurality of lifting surfaces representing different stratum depths in the stratum geometric model;
setting a plurality of sets of different volume expansion coefficients for each lifting surface; and
performing primary simulated lifting on each lifting surface according to the different volume expansion coefficients to correspondingly obtain different primary simulated lifting results for each lifting surface.

According to an aspect of the present disclosure, the selecting a plurality of lifting surfaces representing different stratum depths in the stratum geometric model includes:

selecting a plurality of lifting surfaces representing different stratum depths in a zone of the stratum geometric model where settlement deformation is greatest.

According to an aspect of the present disclosure, a boundary of the stratum geometric model is larger than a boundary of the building geometric model.

According to an aspect of the present disclosure, the geological survey data include a stratigraphic profile and a foundation design parameter table, and the stratum geometric model is constructed using the stratigraphic profile and the foundation design parameter table.

According to an aspect of the present disclosure, the performing a plurality of secondary simulated lifting operations to varying degrees on different lifting surfaces at positions above and below the initial critical lifting surface includes:
taking a plurality of secondary simulated lifting surfaces representing different depths between the initial critical lifting surface and adjacent upper and lower lifting surfaces that participate in the primary simulation lifting; and
performing a plurality of secondary simulated lifting operations to varying degrees on each secondary simulation lifting surface to correspondingly obtain different secondary simulated lifting results for each secondary simulated lifting surface.

According to an aspect of the present disclosure, the determining whether there exists a lifting surface having a larger difference from the initial settlement displacement according to secondary simulated lifting results includes:
obtaining a plurality of secondary simulated settlement displacements of the initial building model after simulated lifting according to secondary simulated lifting results; and
calculating a difference between each secondary simulated settlement displacement and the initial settlement displacement, and then determining whether there exists a difference larger than the difference between the primary simulated settlement displacement and the initial settlement displacement.

According to the solution of the present disclosure, from an overall development perspective, the development of grouting theory still lags behind practice, such that in engineering practice, design and construction are mostly based solely on experience, leading to failures in some projects. The present disclosure applies the Midas-gts modeling system to simulate different grouting effects and perform a comparative analysis, introduces the definition of the critical lifting depth of the building, has a high theoretical guiding significance for engineering practice, and solves the problem of grouting failures caused by construction based solely on experience.

By using the Midas-gts modeling system, the present disclosure applies different expansion coefficients at different stratum depths of the building for trial calculation, respectively, determines the critical lifting depth of the building, identifies the position where the grouting lifting effect is most obvious, provides a numerical simulation reference for engineering practice projects, and facilitates the orderly progression and implementation of subsequent projects.

In an actual grouting process, different grouting design solutions result in significantly different lifting effects. In many cases, problems such as increased project costs due to grout waste and difficulty in controlling the grouting effect easily occur, thereby posing safety hazards to the grouting project. The present disclosure employs a numerical simulation method to achieve both engineering economy and safety.

### BRIEF DESCRIPTION OF DRAWINGS

FIG. 1 schematically shows a flow chart of a method for determining a critical lifting depth of a building based on numerical simulation according to an embodiment of the present disclosure.

FIG. 2 is an initial settlement displacement diagram of an initial building model in Embodiment 1.

FIG. 3 is a plan view of an expansion displacement application zone in Embodiment 1.

FIG. 4 is a profile diagram of an expansion displacement application depth for primary simulated lifting in Embodiment 1.

FIG. 5 is a line chart of a settlement displacement at a characteristic point K1 for primary simulated lifting in Embodiment 1.

FIG. 6 is a line chart of a settlement displacement at a characteristic point K2 for primary simulated lifting in Embodiment 1.

FIG. 7 is a line chart of a settlement displacement at a characteristic point K3 for primary simulated lifting in Embodiment 1.

FIG. 8 is a profile diagram of an expansion displacement application depth for secondary simulated lifting in Embodiment 1.

FIG. 9 is a line chart of a settlement displacement at a characteristic point K1 for secondary simulated lifting in Embodiment 1.

FIG. 10 is a line chart of a settlement displacement at a characteristic point K2 for secondary simulated lifting in Embodiment 1.

FIG. 11 is a line chart of a settlement displacement at a characteristic point K3 for secondary simulated lifting in Embodiment 1.

### DETAILED DESCRIPTION OF THE EMBODIMENTS

The content of the present disclosure will now be discussed with reference to exemplary embodiments. It should be understood that the discussed embodiments are only for the purpose of enabling those of ordinary skill in the art to better understand and thereby implement the content of the present disclosure, and are not intended to imply any limitation on the scope of the present disclosure.

As used herein, the term “includes” and variants thereof are to be interpreted as open-ended terms meaning “includes, but is not limited to”. The term “based on” is to be interpreted as “based at least in part on”. The term “one embodiment” and “an embodiment” are to be interpreted as “at least one embodiment”.

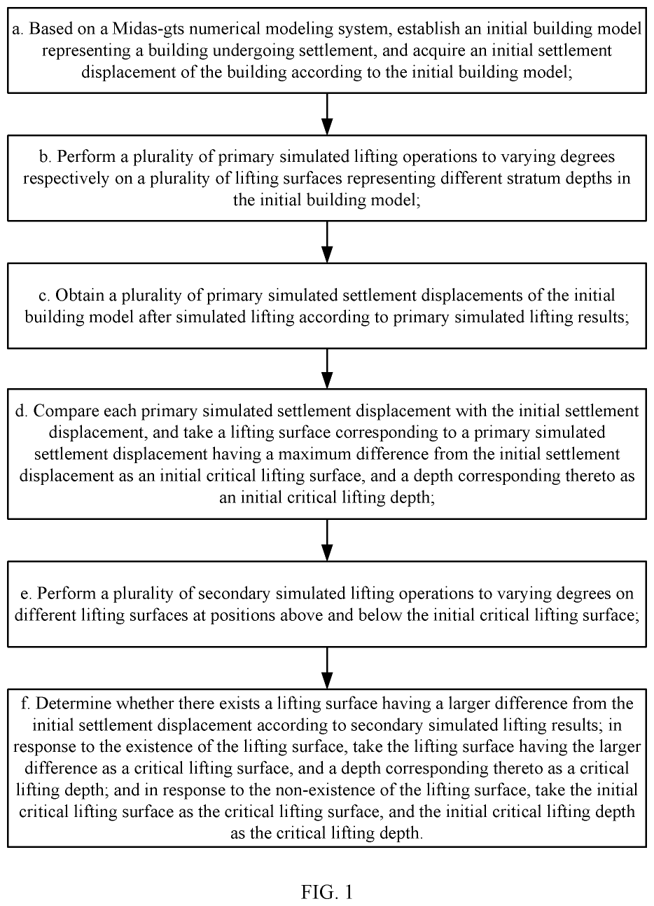

FIG. 1 schematically shows a flow chart of a method for determining a critical lifting depth of a building based on numerical simulation according to an embodiment of the present disclosure. As shown in FIG. 1, a method for determining a critical lifting depth of a building based on numerical simulation includes:
a. based on a Midas-gts numerical modeling system, an initial building model representing a building undergoing settlement is established, and an initial settlement displacement of the building is acquired according to the initial building model;
b. a plurality of primary simulated lifting operations to varying degrees are performed respectively on a plurality of lifting surfaces representing different stratum depths in the initial building model;
c. a plurality of primary simulated settlement displacements of the initial building model after simulated lifting are obtained according to primary simulated lifting results;
d. each primary simulated settlement displacement is compared with the initial settlement displacement, a lifting surface corresponding to a primary simulated settlement displacement having a maximum difference from the initial settlement displacement is taken as an initial critical lifting surface, and a depth corresponding thereto is taken as an initial critical lifting depth;
e. a plurality of secondary simulated lifting operations to varying degrees are performed on different lifting surfaces at positions above and below the initial critical lifting surface; and
f. whether there exists a lifting surface having a larger difference from the initial settlement displacement is determined according to secondary simulated lifting results; in response to the existence of the lifting surface, the lifting surface having the larger difference is taken as a critical lifting surface, and a depth corresponding thereto is taken as a critical lifting depth; and in response to the non-existence of the lifting surface, the initial critical lifting surface is taken as the critical lifting surface, and the initial critical lifting depth is taken as the critical lifting depth.

According to an embodiment of the present disclosure, in the above step a, the establishing an initial building model representing a building undergoing settlement includes:
based on a Midas-gts numerical modeling system, a stratum geometric model and a building geometric model are established according to geological survey data parameters and building construction drawing data parameters;
material property parameters are input into the stratum geometric model and the building geometric model, respectively;
the stratum geometric model and the building geometric model are meshed; and
gravity loads and static soil boundary conditions are loaded onto the meshed stratum geometric model and building geometric model to form the initial building model; where
the material property parameters include an elastic modulus, a void ratio, a Poisson's ratio, and a unit weight.

In this embodiment, the stratum geometric model and the building geometric model are established according to data such as geological survey data and building construction drawings, the material property parameters are input, and the loads and boundary conditions are added to form the above initial building model. After the initial building model is calculated, the initial building model includes a stress diagram, a strain diagram, a settlement deformation diagram, a bending moment diagram, a shear force diagram, and the like, and the initial settlement displacement of the building in the above step a may be acquired from the settlement deformation diagram. The content related to the settlement displacement described below can also be acquired from the corresponding settlement deformation diagram in each model, and the related content will not be repeated.

Further, according to an embodiment of the present disclosure, the performing a plurality of primary simulated lifting operations to varying degrees respectively on a plurality of lifting surfaces representing different stratum depths in the initial building model in the above b includes:
a plurality of lifting surfaces (primary simulated lifting surfaces, i.e., lifting surfaces used for the first simulated lifting) representing different stratum depths are selected in the stratum geometric model;
a plurality of sets of different volume expansion coefficients are set for each lifting surface; and
primary simulated lifting is performed on each lifting surface according to the different volume expansion coefficients to correspondingly obtain different primary simulated lifting results (i.e., different lifting results corresponding to the different volume expansion coefficients) for each lifting surface. With this configuration, the grouting pressure effect is simulated using the volume expansion coefficients to induce soil volume expansion, generate an expansion displacement, and squeeze an overlying soil layer, thereby achieving the purpose of lifting the overlying building.

In this embodiment, the selecting a plurality of lifting surfaces representing different stratum depths in the stratum geometric model includes:
a plurality of lifting surfaces representing different stratum depths are selected in a zone of the stratum geometric model where settlement deformation is greatest. With this configuration, after applying an expansion displacement to the zone with the greatest deformation, a larger space for lifting is available, and the lifting effect is more obvious, which is more conducive to observing and summarizing data patterns, and identifying the critical lifting depth.

Further, in this embodiment, a boundary of the stratum geometric model is larger than a boundary of the building geometric model. With this configuration, an influence of the boundary conditions of the stratum geometric model on the grouting process may be effectively reduced.

Further, in this embodiment, the geological survey data include a stratigraphic profile and a foundation design parameter table, and the stratum geometric model is constructed using the stratigraphic profile and the foundation design parameter table. That is, actual soil layer profile parameters are used when the stratum geometric model is established. With this configuration, the stratum settlement condition can be reflected more realistically, and the uneven settlement displacement of the building can be simulated more accurately.

Further, according to an embodiment of the present disclosure, in the above step c, a plurality of primary simulated settlement displacements of the initial building model after simulated lifting are obtained according to primary simulated lifting results. That is, after the primary simulated lifting is performed on each lifting surface with different volume expansion coefficients, the settlement displacement of the initial building model after lifting is obtained from the settlement deformation diagram for each lifting surface, i.e., the above primary simulated settlement displacement. This settlement displacement is obtained after simulating grouting lifting by applying the volume expansion coefficient. By comparing this settlement displacement with the initial settlement displacement, the lifting effect of each lifting surface can be known. The smaller the primary simulated settlement displacement, the more obvious the lifting effect, i.e., the larger the difference between the initial settlement displacement and the primary simulated settlement displacement, indicating that the lifting surface has the most obvious lifting effect.

Further, according to an embodiment of the present disclosure, in the above step d, each primary simulated settlement displacement is compared with the initial settlement displacement, the lifting surface corresponding to the primary simulated settlement displacement having the maximum difference from the initial settlement displacement is taken as the initial critical lifting surface, and the depth corresponding thereto is taken as the initial critical lifting depth. With this configuration, an initial critical lifting surface can be obtained as a coarse critical lifting surface. Compared with other lifting surfaces, this initial critical lifting surface has a better lifting effect, but there may be lifting surfaces with an even better lifting effect in a small range above and below the initial critical lifting surface. Therefore, this lifting surface is an initial critical lifting surface, not a final critical lifting surface.

Further, according to an embodiment of the present disclosure, in the above step e, the performing a plurality of secondary simulated lifting operations (i.e., second simulation lifting operations) to varying degrees on different lifting surfaces at positions above and below the initial critical lifting surface includes:
a plurality of secondary simulated lifting surfaces (lifting surfaces used for the second simulated lifting) representing different depths are taken between the initial critical lifting surface and adjacent upper and lower lifting surfaces that participate in the primary simulation lifting; and
a plurality of secondary simulated lifting operations to varying degrees are performed on each secondary simulation lifting surface to correspondingly obtain different secondary simulated lifting results for each secondary simulated lifting surface. With this configuration, small-range verification and determination may be performed on the initial critical lifting surface. Through verification, it is identified whether other lifting surfaces adjacent thereto may serve as the critical lifting surface.

Further, according to an embodiment of the present disclosure, in the above step f, the determining whether there exists a lifting surface having a larger difference from the initial settlement displacement according to secondary simulated lifting results includes:
a plurality of secondary simulated settlement displacements of the initial building model after simulated lifting are obtained according to secondary simulated lifting results; and
a difference between each secondary simulated settlement displacement and the initial settlement displacement is calculated, and then whether there exists a difference larger than the difference between the primary simulated settlement displacement and the initial settlement displacement is determined. In this embodiment, in response to the existence of the larger difference, the lifting surface having the larger difference (i.e., the secondary simulated lifting surface) is taken as a critical lifting surface, and a depth corresponding thereto is taken as a critical lifting depth; and in response to the non-existence of the larger difference, the initial critical lifting surface is taken as the critical lifting surface, and the initial critical lifting depth is taken as the critical lifting depth. With this configuration, the obtained critical lifting depth may be more accurate and precise. When construction lifting is performed according to the critical lifting depth, the lifting effect is more obvious.

In the present disclosure, the settlement displacement refers to the settlement displacement at a bottom of a building raft foundation.

In the present disclosure, according to the settlement deformation induced after applying the expansion coefficient at the critical lifting depth, the expansion coefficient required per unit lifting depth of the building may be calculated, and then the expansion coefficients required for lifting other settlement zones may be derived according to the expansion coefficient required per unit lifting depth of the building.

According to the above solution of the present disclosure, from an overall development perspective, the development of grouting theory still lags behind practice, such that in engineering practice, design and construction are mostly based solely on experience, leading to failures in some projects. The present disclosure applies the Midas-gts modeling system to simulate different grouting effects and perform a comparative analysis, introduces the definition of the critical lifting depth of the building, has a high theoretical guiding significance for engineering practice, and solves the problem of grouting failures caused by construction based solely on experience.

By using the Midas-gts modeling system, the present disclosure applies different expansion coefficients at different stratum depths of the building for trial calculation, respectively, determines the critical lifting depth of the building, identifies the position where the grouting lifting effect is most obvious, provides numerical simulation reference for engineering practice projects, and facilitates the orderly progression and implementation of subsequent projects.

In an actual grouting process, different grouting design solutions result in significantly different lifting effects. In many cases, problems such as increased project costs due to grout waste and difficulty in controlling the grouting effect easily occur, thereby posing safety hazards to the grouting project. The present disclosure employs a numerical simulation method to achieve both engineering economy and safety.

Based on the above solution of the present disclosure, the solution of the present disclosure is described below in detail in a specific embodiment in combination with the drawings.

### Embodiment 1

For a certain residential building project, the building has one underground floor with a floor height of −5.0 m, and 26 above-ground floors, with a first floor height of 5.000 m and the remaining floor heights of 2.900 m. A raft foundation rests on a pebble layer. A bearing layer is a pebble layer with a high porosity, and settlement occurs due to insufficient foundation bearing capacity. The foundation design parameters in the geological survey are shown in Table 1 below:

TABLE 1

| | | Characteristic | | |
|---|---|---|---|---|
| | Natural unit | value of subgrade | | |
| Stratum No. | weight | bearing capacity | Es1-2 | Poisson's |
| and name | γ (kN/m³) | fak (kPa) | (MPa) | ratio |
| Plain fill \textcircled{1} | 18.0* | (under-consolidated | 2.0 | 0.15 |
| | | and uneven, not | | |
| | | provided) | | |
| Pebble \textcircled{2} | 20.0* | 300 | 22.1 | 0.29 |
| Argillaceous | 22.0 | 450 | 30.0 | 0.28 |
| siltstone \textcircled{3}-1 | | | | |
| Argillaceous | 22.0 | 1800 | 20.0 | 0.25 |
| siltstone \textcircled{3}-2 | | | | |
| Strongly | 21.5* | 600 | 20.0 | 0.2 |
| weathered | | | | |
| dolomite \textcircled{4}-1 | | | | |
| Moderately | 23.0* | 3000 | 5.0 | 0.2 |
| weathered | | | | |
| dolomite \textcircled{4}-2 | | | | |

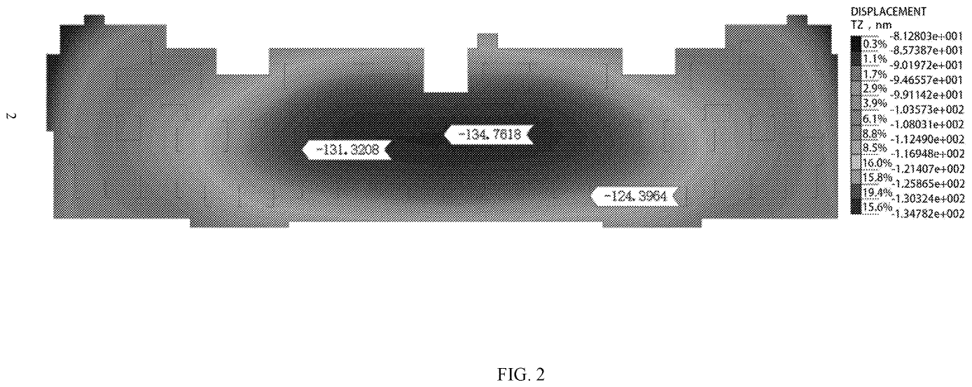

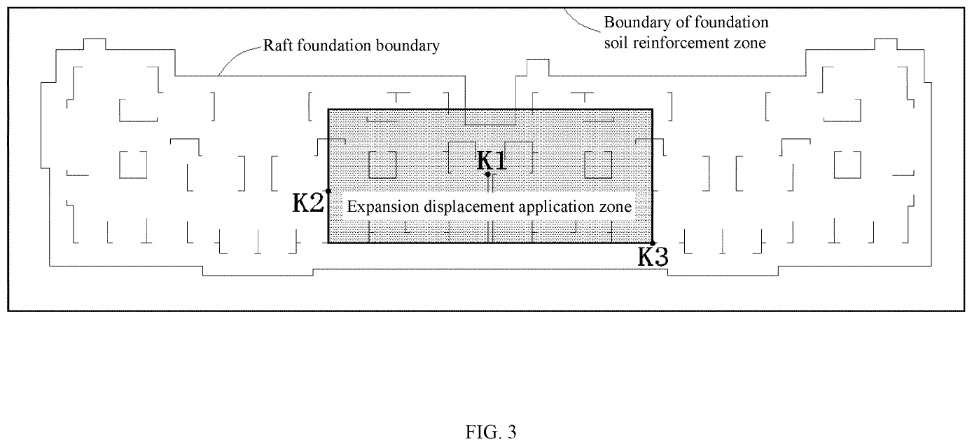

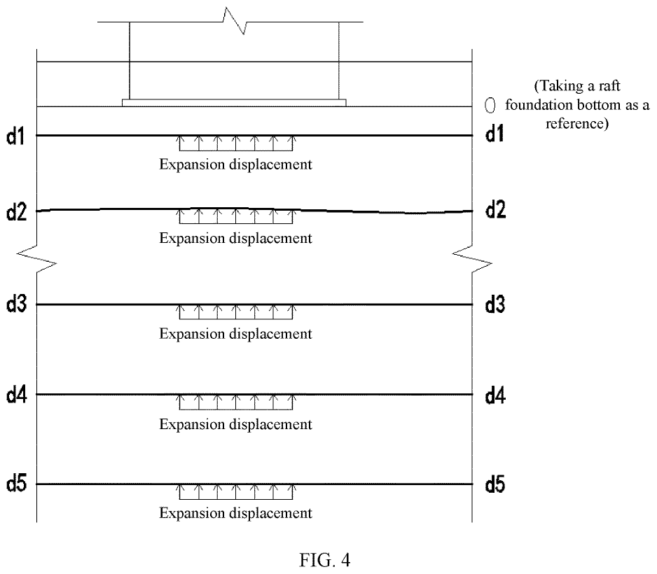

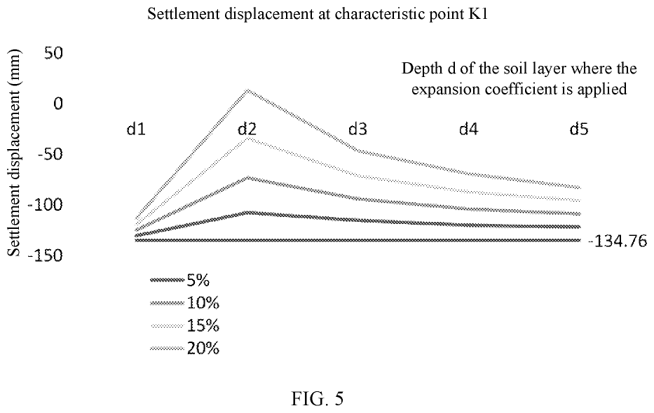

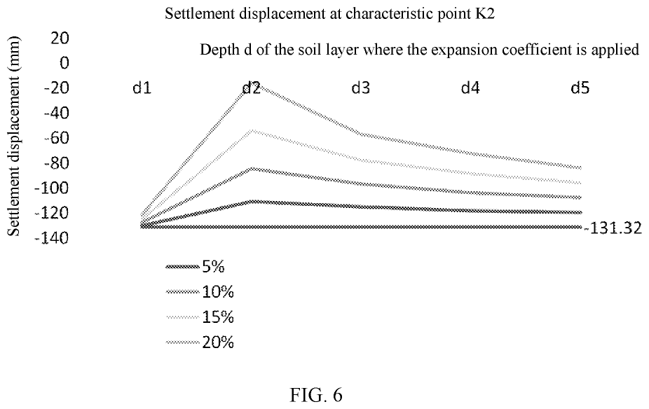

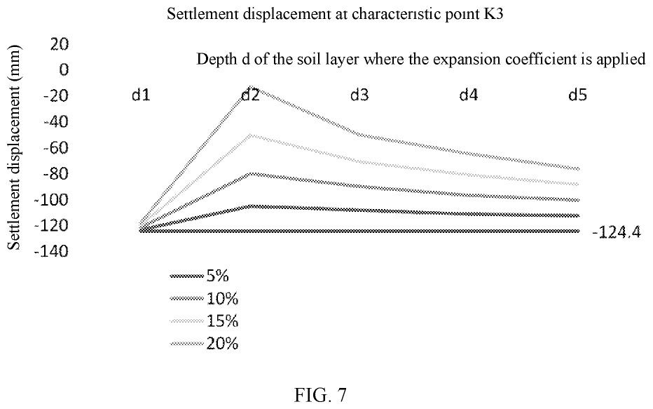

A Midas-gts modeling analysis was performed on a typical building with a raft foundation to verify the feasibility of an actual compaction grouting rectification and building lifting construction solution, thereby providing a reference example for similar projects:
Step 1, an initial building model was formed. According to data such as geological survey data and building construction drawings, stratum and building models were established, and materials and property parameters were input. An elastic modulus was taken as twice Es1-2, and parameters such as a Poisson's ratio and a unit weight were selected according to the data in the table. Gravity loads and static soil boundary conditions were added to form an initial model, and calculation was performed to obtain an initial settlement displacement, as shown in FIG. 2.
Step 2, an initial critical lifting depth do was determined. Different magnitudes of volume expansion coefficients (expansion displacement) were applied at different stratum depths corresponding to zones with a relatively large foundation settlement displacement in the initial building model, and calculation was performed, as shown in FIG. 2, FIG. 3, and FIG. 4. Characteristic points K1, K2, and K3 were selected in the zone where the expansion coefficient is applied. The settlement deformations (primary simulated settlement displacements) of the characteristic points K1, K2, and K3 at different depths (in this embodiment, the characteristic points were selected as a center point, an edge point, and a corner point of the zone with a largest settlement deformation, such that the selected characteristic points were more representative, and the lifting effect could be better observed, thereby facilitating pattern summarization and identification of an optimal critical lifting depth) and with different “volume expansion coefficients ε” were recorded, and filled into tables, and line charts were formed, as shown in Table 2, Table 3, and Table 4 below as well as FIG. 5, FIG. 6, and FIG. 7.

TABLE 2

| Depth of soil layer where the | Expansion coefficient | | | |
|---|---|---|---|---|
| expansion coefficient is applied | 5% | 10% | 15% | 20% |
| d1 | −130.42 | −124.85 | −119.13 | −113.15 |
| d2 | −107.67 | −73.35 | −34.22 | 13.35 |
| d3 | −115.30 | −93.94 | −71.26 | −46.48 |
| d4 | −120.21 | −104.15 | −87.12 | −69.37 |
| d5 | −121.74 | −108.77 | −95.83 | −82.94 |

TABLE 3

| Depth of soil layer where the | Expansion coefficient | | | |
|---|---|---|---|---|
| expansion coefficient is applied | 5% | 10% | 15% | 20% |
| d1 | −129.94 | −127.30 | −124.43 | −121.30 |
| d2 | −110.84 | −84.51 | −54.09 | −16.03 |
| d3 | −114.95 | −96.81 | −77.68 | −57.00 |
| d4 | −118.26 | −103.81 | −88.45 | −72.43 |
| d5 | −119.38 | −107.47 | −95.61 | −83.79 |

TABLE 4

| Depth of soil layer where the | Expansion coefficient | | | |
|---|---|---|---|---|
| expansion coefficient is applied | 5% | 10% | 15% | 20% |
| d1 | −123.06 | −121.28 | −119.58 | −117.88 |
| d2 | −104.96 | −79.85 | −50.43 | −13.08 |
| d3 | −108.00 | −89.80 | −70.70 | −50.11 |
| d4 | −111.16 | −96.52 | −80.94 | −64.68 |
| d5 | −112.28 | −100.22 | −88.19 | −76.20 |

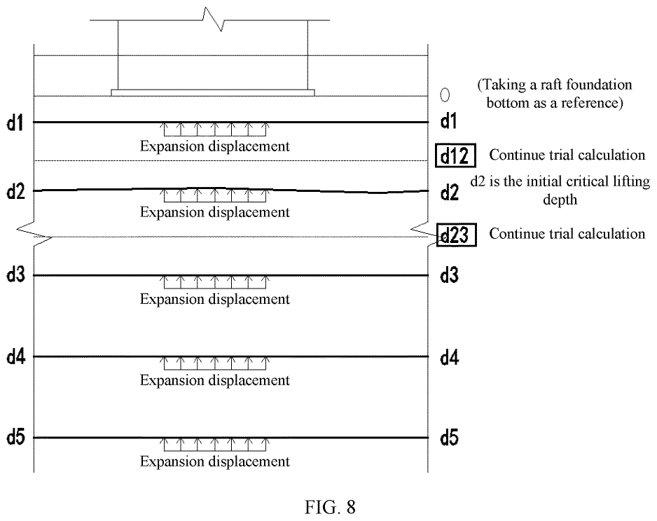

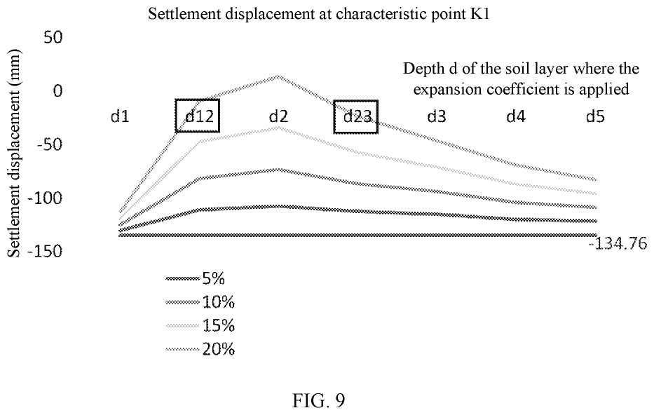

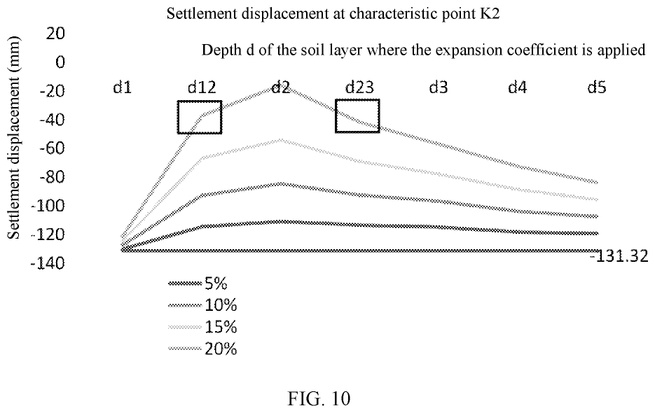

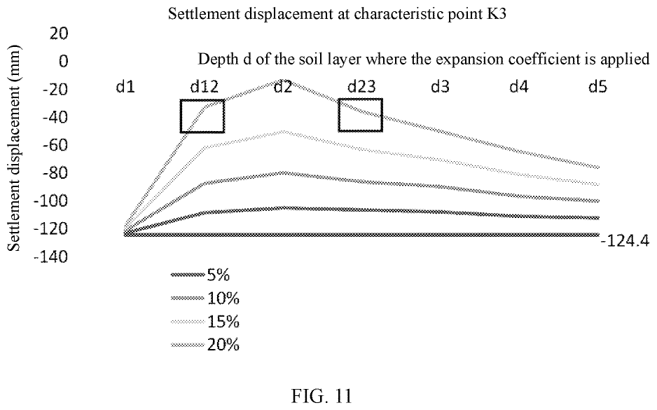

The initial settlement values of the characteristic points K1, K2, and K3 when no expansion coefficient was applied were-134.76 mm,-131.32 mm, and-124.40 mm, respectively. After applying the expansion coefficient to simulate lifting, the settlement displacements changed. By analyzing the data in the above tables, at a depth d2, a displacement settlement deformation value (i.e., the primary simulated settlement displacement value) was the smallest, indicating the most obvious lifting effect. Therefore, the initial critical lifting depth do was determined as d2.
Step 3, a critical lifting depth dL was determined. Expansion coefficients were continuously applied in a small range above and below the depth do for trial calculation (i.e., secondary simulated lifting) to determine whether there exists a depth dL such that the settlement deformation at dL is smaller than the settlement deformation at do. This depth was selected as a critical lifting depth dL. For example, as shown in FIG. 8, the “volume expansion coefficients ε” were continuously applied at depths d12 and d23 (i.e., depths corresponding to the secondary simulated lifting surfaces) above and below the depth d2 for trial calculation. It was identified that the settlement displacement values at the depths d12 and d23 were greater than the settlement displacement value at the depth d2, and the lifting effects at the depths d12 and d23 were not as good as the lifting effect at d2. Therefore, the depth d2 was a turning point, and the critical lifting depth dL was determined as d2, as shown in Table 5, Table 6, as well as Table 7 below and FIG. 9, FIG. 10, and FIG. 11.

TABLE 5

| Depth of soil layer where the | Expansion coefficient | | | |
|---|---|---|---|---|
| expansion coefficient is applied | 5% | 10% | 15% | 20% |
| d1 | −130.42 | −124.85 | −119.13 | −113.15 |
| d12 | −111.10 | −81.70 | −47.39 | −9.19 |
| d2 | −107.67 | −73.35 | −34.22 | 13.35 |
| d23 | −112.39 | −86.58 | −57.48 | −23.76 |
| d3 | −115.30 | −93.94 | −71.26 | −46.48 |
| d4 | −120.21 | −104.15 | −87.12 | −69.37 |
| d5 | −121.74 | −108.77 | −95.83 | −82.94 |

TABLE 6

| Depth of soil layer where the | Expansion coefficient | | | |
|---|---|---|---|---|
| expansion coefficient is applied | 5% | 10% | 15% | 20% |
| d1 | −129.94 | −127.30 | −124.43 | −121.30 |
| d12 | −114.42 | −92.69 | −66.73 | −37.13 |
| d2 | −110.84 | −84.51 | −54.09 | −16.03 |
| d23 | −113.27 | −92.48 | −69.12 | −41.72 |
| d3 | −114.95 | −96.81 | −77.68 | −57.00 |
| d4 | −118.26 | −103.81 | −88.45 | −72.43 |
| d5 | −119.38 | −107.47 | −95.61 | −83.79 |

TABLE 7

| Depth of soil layer where the | Expansion coefficient | | | |
|---|---|---|---|---|
| expansion coefficient is applied | 5% | 10% | 15% | 20% |
| d1 | −123.06 | −121.28 | −119.58 | −117.88 |
| d12 | −108.37 | −87.31 | −61.87 | −32.65 |
| d2 | −104.96 | −79.85 | −50.43 | −13.08 |
| d23 | −106.56 | −86.18 | −63.23 | −36.00 |
| d3 | −108.00 | −89.80 | −70.70 | −50.11 |
| d4 | −111.16 | −96.52 | −80.94 | −64.68 |
| d5 | −112.28 | −100.22 | −88.19 | −76.20 |

Finally, it should be noted that the above preferred embodiment is only used to illustrate the technical solution of the present disclosure, rather than limiting the technical solution. Although the present disclosure has been described in detail through the above preferred embodiment, those skilled in the art should understand that various changes in form and detail may be made without departing from the scope defined by the claims of the present disclosure.

What is claimed is:

1. A method for determining a critical lifting depth of a building based on numerical simulation, comprising:
based on a Midas-gts numerical modeling system, establishing an initial building model representing a building undergoing settlement, and acquiring an initial settlement displacement of the building according to the initial building model;
performing a plurality of primary simulated lifting operations to varying degrees respectively on a plurality of lifting surfaces representing different stratum depths in the initial building model;
obtaining a plurality of primary simulated settlement displacements of the initial building model after simulated lifting according to primary simulated lifting results;
comparing each primary simulated settlement displacement with the initial settlement displacement, and taking a lifting surface corresponding to a primary simulated settlement displacement having a maximum difference from the initial settlement displacement as an initial critical lifting surface, and a depth corresponding thereto as an initial critical lifting depth;
performing a plurality of secondary simulated lifting operations to varying degrees on different lifting surfaces at positions above and below the initial critical lifting surface; and
determining whether there exists a lifting surface having a larger difference from the initial settlement displacement according to secondary simulated lifting results; in response to the existence of the lifting surface, taking the lifting surface having the larger difference as a critical lifting surface, and a depth corresponding thereto as a critical lifting depth; and in response to the non-existence of the lifting surface, taking the initial critical lifting surface as the critical lifting surface, and the initial critical lifting depth as the critical lifting depth.

2. The method for determining a critical lifting depth of a building based on numerical simulation according to claim 1, wherein the establishing an initial building model representing a building undergoing settlement comprises:
based on a Midas-gts numerical modeling system, establishing a stratum geometric model and a building geometric model according to geological survey data parameters and building construction drawing data parameters;
inputting material property parameters into the stratum geometric model and the building geometric model, respectively;
meshing the stratum geometric model and the building geometric model; and
loading gravity loads and static soil boundary conditions onto the meshed stratum geometric model and building geometric model to form the initial building model; where
the material property parameters comprise an elastic modulus, a void ratio, a Poisson's ratio, and a unit weight.

3. The method for determining a critical lifting depth of a building based on numerical simulation according to claim 2, wherein the performing a plurality of primary simulated lifting operations to varying degrees respectively on a plurality of lifting surfaces representing different stratum depths in the initial building model comprises:
selecting a plurality of lifting surfaces representing different stratum depths in the stratum geometric model;
setting a plurality of sets of different volume expansion coefficients for each lifting surface; and
performing primary simulated lifting on each lifting surface according to the different volume expansion coefficients to correspondingly obtain different primary simulated lifting results for each lifting surface.

4. The method for determining a critical lifting depth of a building based on numerical simulation according to claim 3, wherein the selecting a plurality of lifting surfaces representing different stratum depths in the stratum geometric model comprises:
selecting a plurality of lifting surfaces representing different stratum depths in a zone of the stratum geometric model where settlement deformation is greatest.

5. The method for determining a critical lifting depth of a building based on numerical simulation according to claim 2, wherein a boundary of the stratum geometric model is larger than a boundary of the building geometric model.

6. The method for determining a critical lifting depth of a building based on numerical simulation according to claim 2, wherein the geological survey data comprise a stratigraphic profile and a foundation design parameter table, and the stratum geometric model is constructed using the stratigraphic profile and the foundation design parameter table.

7. The method for determining a critical lifting depth of a building based on numerical simulation according to claim 1, wherein the performing a plurality of secondary simulated lifting operations to varying degrees on different lifting surfaces at positions above and below the initial critical lifting surface comprises:
taking a plurality of secondary simulated lifting surfaces representing different depths between the initial critical lifting surface and adjacent upper and lower lifting surfaces that participate in the primary simulation lifting; and
performing a plurality of secondary simulated lifting operations to varying degrees on each secondary simulation lifting surface to correspondingly obtain different secondary simulated lifting results for each secondary simulated lifting surface.

8. The method for determining a critical lifting depth of a building based on numerical simulation according to claim 1, wherein the determining whether there exists a lifting surface having a larger difference from the initial settlement displacement according to secondary simulated lifting results comprises:
obtaining a plurality of secondary simulated settlement displacements of the initial building model after simulated lifting according to secondary simulated lifting results; and
calculating a difference between each secondary simulated settlement displacement and the initial settlement displacement, and then determining whether there exists a difference larger than the difference between the primary simulated settlement displacement and the initial settlement displacement.
